(19) United States
(12) Patent Application Publication
(10) Pub. No.: US 2004/0193824 A1
(43) Pub. Date: Sep. 30, 2004

(54) Expandable capacity storage device

(76) Inventor: Steven C. Johnson, Eagle, ID (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/396,000

(22) Filed: Mar. 24, 2003

(51) Int. Cl. G06F 12/00

(52) U.S. Cl. 711/170; 711/115

(57) ABSTRACT

Expandable capacity storage devices are disclosed. In one arrangement, a storage device includes a memory module and a controller that is in communication with the memory module, the controller being configured to selectively enable previously inaccessible free space of storage device memory to increase the available storage capacity of the storage device. Also disclosed are methods for increasing the available storage capacity of a storage device having an initial available storage capacity. In one arrangement, a method includes providing identification of the amount of storage capacity that is needed, receiving a memory enablement code that identifies how much free space to enable on the storage device, and enabling additional free space of the storage device based upon the amount of memory identified by the memory enablement code so as to increase the available storage capacity of the storage device.

### FIELD OF THE INVENTION

The present disclosure relates to storage devices. More particularly, the present disclosure relates to storage devices whose available storage capacities can be increased beyond an initial available storage capacity.

### BACKGROUND OF THE INVENTION

Many types of electronic devices such as notebook computers, personal digital assistants (PDAs), and digital cameras employ storage devices that are used, to store various generated and/or collected data. Often, these storage devices are removable. For example, flash memory cards have become increasingly popular over the last several years with users of portable electronic devices.

One problem associated with known storage devices is that the amount of data they can store is often limited. Due to the demand for greater storage capacities, new memory technologies have been developed that have significantly more storage capacity than existing storage devices.

Although the availability of higher capacity storage devices has addressed the need for greater storage capability, other problems still exist. First, not everyone requires particularly high storage capacity. Therefore, where only high capacity storage devices are available, the user may be forced to purchase significantly more memory than the user needs. This may deter such users from buying an electrical device or storage device for use with an electrical device because the user feels that he or she will be purchasing memory that he or she will never use.

Although it is possible to produce a variety of different storage devices each having a different storage capacity, the expense for the manufacturer to engineer and market several different storage capacity versions of a given memory technology is unattractive. Moreover, there are often only a few storage capacity choices available due to manufacturing techniques used to fabricate the memory. Specifically, some memory technologies have a minimum threshold capacity below which fabrication costs become prohibitive. Indeed, most memory technologies have a “sweet spot,” i.e., a capacity range (e.g., bit range) in which fabrication costs are cheapest and yields are highest.

A further drawback of currently-available storage devices is that users often determine that they need more storage capacity than they have available from the storage devices they currently possess. To obtain more memory, the user must purchase one or more additional storage devices, resulting in a greater expenditure than if the user had just purchased the higher capacity storage device from the beginning. Although users could avoid this problem by only purchasing high capacity storage devices, they may be hesitant to do so for fear of buying more capacity than they need.

### SUMMARY OF THE INVENTION

In view of the above, it can be appreciated that it would be desirable to have a system and method for providing varying amounts of storage capacity without having to produce multiple versions of storage devices. In one embodiment of the invention, a storage device comprises a memory module and a controller that is in communication with the memory module, the controller being configured to selectively enable previously inaccessible free space of storage device memory to increase the available storage capacity of the storage device.

Embodiments of the invention to methods for increasing the available storage capacity of a storage device having an initial available storage capacity. In one arrangement, a method comprises providing identification of the amount of storage capacity that is needed, receiving a memory enablement code that identifies how much free space to enable on the storage device, and enabling additional memory of the storage device based upon the amount of free space identified by the memory enablement code so as to increase the available storage capacity of the storage device.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a perspective view of an example expandable capacity storage device in which embodiments of the invention may be used to an advantage.

FIG. 2 is a block diagram of the storage device shown in FIG. 1.

FIG. 3 is a flow diagram of a method for expanding the available storage capacity of a storage device.

FIGS. 4A and 4B illustrate a second method for expanding the available storage capacity of a storage device.

FIGS. 5A and 5B illustrate a third method for expanding the available storage capacity of a storage device.

### DETAILED DESCRIPTION

As identified above, storage devices having different storage capacities are needed, but it is undesirable to produce, or have to purchase, multiple storage devices for the storage needs. Disclosed herein are systems and methods in which a single storage device is produced having a given absolute amount of memory, but whose available storage capacity is variable so that, as the need for more storage arises, the user can access a greater portion of the free space within the device memory to thereby increase the capacity of the device. As is discussed in greater detail below, this scheme can be implemented for storage devices that include a controller that controls the amount of memory that may be accessed by the host system that uses the storage device.

In some arrangements, the available storage capacity of the storage device can be expanded in exchange for a fee. In such a scenario, the user purchases, for a relatively low cost, a storage device having a first available storage capacity and, if desired, pay an additional, relatively small fee to later increase the available storage capacity of the device. Thus, users are able to purchase a single-produced storage device that has the storage capacity, whether small or large, they feel they need.

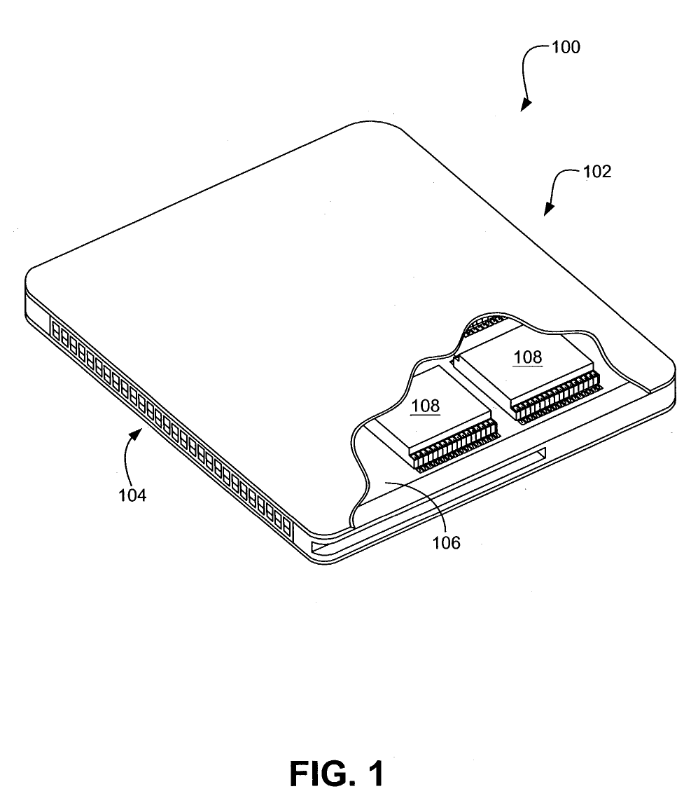

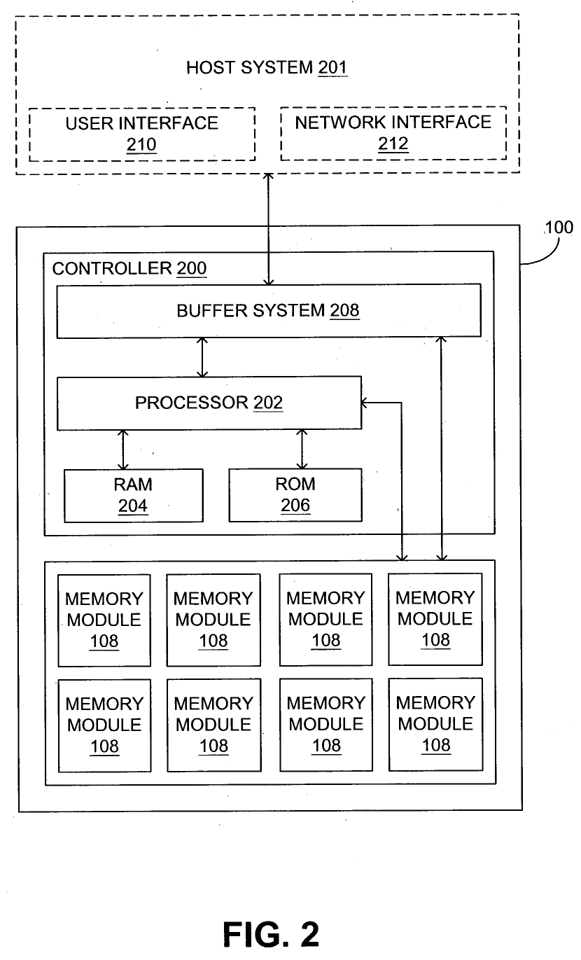

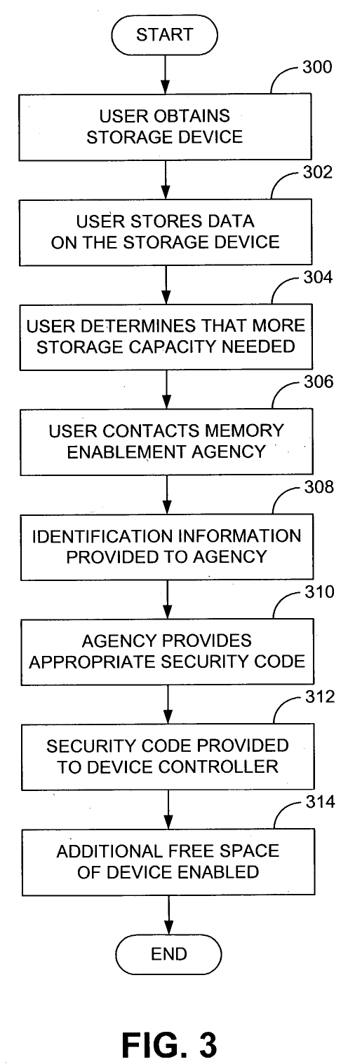

Referring now in more detail to the drawings, in which like numerals indicate corresponding parts throughout the several views, FIGS. 1 and 2 illustrate an example removable storage device 100 whose available storage capacity can be increased. As indicated in FIG. 1, the storage device 100 can be arranged as a storage card that comprises a housing 102 and an integral connector 104. Although a card-type device is illustrated and described herein, persons having ordinary skill in the art will appreciate from the present disclosure that other types of storage devices can be used. Where the storage device 100 is a card-type device, the connector 104 can comprise a multi-pin connector that is adapted for connection with a mating connector of a suitable host system. The host system may, for example, comprise a host device such as a notebook computer, personal digital assistant (PDA), digital camera, etc. Although a particular type of connector is illustrated in the figure, it will be appreciated that alternative connectors can be used.

The housing 102 defines an interior space that typically contains a printed circuit board (PCB) 106 on which one or more memory modules 108 are mounted. Although a PCB is illustrated and described herein, persons having ordinary skill in the art will appreciate that alternative mounting technologies could be used such as flex circuits, thick films, etc. Normally, the memory modules 108 are surface mounted to the PCB 106 (on one or both sides) and electrically connected thereto such that each memory module is in electrical communication with the other memory modules on the board to provide for storage redundancy. At least one of the memory modules 108 is provided within the housing 102. As is discussed in greater detail below, the memory modules 108 preferably comprise atomic resolution storage (ARS) devices, magnetic random access memory (MRAM) devices, or write-once memory modules that include a cross-point array of thin-film, write-once memory cells.

FIG. 2 provides an example configuration for the storage device 100. As indicated in this figure, the storage device 100 can generally comprise a controller 200 and at least one memory module 108. The controller 200 can comprise a single integrated component (e.g., an application specific integrated circuit (ASIC)) and/or a plurality of discrete components that together provide a control functionality. Typically, however, the controller 200 is formed as an integrated semiconductor device that is used to control and manage operation of the storage device 100. In addition, as described in greater detail below, the controller 200 is used to selectively enable portions of memory to adjust the available storage capacity of the storage device 100. Therefore, the controller 200 is configured to unlock partitioned portions of memory that previously were unknown to the host system 201.

As indicated in FIG. 2, the controller 200 can comprise a processor 202, random access memory (RAM) 204, read-only memory (ROM) 206, and a buffer system 208. The processor 202 controls operation of the controller 200 in accordance with boot and operating code (e.g., firmware) stored within the ROM 206. In addition to storing this code, the ROM 206 comprises, in some arrangements, an embedded decoder program that, when executed in RAM 204, is used to support a security scheme to guard against unauthorized expansion of the available storage capacity of the storage device 100. In such cases, the ROM 206 may also store a key that is used in the decoding process. Although the decoder program and the key are described as being stored in ROM 206, persons having ordinary skill in the art will appreciate that, alternatively, these components could be stored elsewhere, such as in one or more of the memory modules 108, if desired. Moreover, although a decoder program is identified, persons having ordinary skill will appreciate that a hardware-based decoder could, alternatively, be used, if desired.

The processor 202 is configured to receive storage commands from the host system via the buffer system 208, and control the delivery of blocks of data to designated storage device addresses of the various memory modules 108. When data are to be written to the storage device 100, write commands are received by the processor 202 that typically specify linear addresses to be associated with the data. The addresses are then converted (i.e., mapped) by the processor 202 to an appropriate storage device address. The RAM 204 can be used by the processor 202 as a computing resource during this mapping. The processor 202 then causes the buffer system 208 to forward the data to the memory modules 108 so that the data are written to the mapped storage device addresses.

During a read, read commands are received by the processor 202 that typically specify the linear addresses associated with the data that is to be read. The processor 202 maps the linear addresses to the associated storage device addresses, fetches the data, organizes it into blocks of data, and passes it to the buffer system 208, which, in turn, provides the data to the host system.

As is further indicated in FIG. 2, the host system can comprise a user interface 210 and a network interface 212 that, as described below, facilitate the memory enablement process.

Although the memory modules 108 can comprise any device capable of storing a large amount of data, the memory modules, in one preferred embodiment, comprise ARS devices due to their low cost-per-bit and high capacity. A detailed description of a suitable ARS device is disclosed in U.S. Pat. No. 5,557,596, which is hereby incorporated by reference into the present disclosure.

In an alternative preferred arrangement, the memory modules 108 comprise magnetic memory modules such as MkAM devices. Although MRAM devices typically do not have the storage capacity of ARS devices, the use of MRAM devices is advantageous in terms of transfer rate performance in that MRAM devices can write, and read, data with great speed. An example MRAM device suitable for use in the memory modules 108 is disclosed in U.S. Pat. No. 6,111,783, which is hereby incorporated by reference into the present disclosure. In another alternative arrangement, the memory modules 108 comprise write-once memory modules that include cross-point arrays of thin-film, write-once memory cells. An example of such a device is disclosed in U.S. Pat. No. 6,324,093, which is hereby incorporated by reference into the present disclosure.

Although three particular memory technologies have been identified as potential implementations for the storage device 100, it is to be appreciated that any memory technology that is used in conjunction with a controller that can selectively enable (or disable) portions of memory could be used in the storage device 100. Accordingly, other solid-state memory, such as flash memory, could be used, if desired. Indeed, as will be apparent from the discussions that follow, the storage device could even include conventional memory technologies, such as magnetic disk technologies used in disk drives, if the storage device includes an appropriate controller.

An example storage device 100 having been described above, use and operation of the storage device will now be discussed. In the discussion that follows, flow diagrams are provided. It is to be understood that process steps or blocks in these flow diagrams may represent modules, segments, or portions of code that include one or more executable instructions for implementing specific logical functions in the process. It will be appreciated that, although particular example processes are described, alternative implementations are feasible. Moreover, steps may be executed out of order from that shown or discussed, including substantially concurrently or in reverse order, depending on the functionality involved.

Using the storage technology described above, a single absolute capacity storage device can be produced whose available storage capacity is variable. Accordingly, a manufacturer need not develop multiple versions of storage devices to provide different storage capacities. The storage device can therefore be pre-configured so as to have a predetermined amount available storage capacity, and its price can reflect this amount of capacity. In addition to enabling the manufacturer to produce a single storage device while simultaneously satisfying demand for varying desired storage capacity levels, the disclosed storage technology further permits the manufacturer to produce devices in the “sweet spot” of the particular memory technology that is employed in the storage device.

The above-described storage technology further enables the user to later expand the amount of available storage capacity as needed. FIG. 13 provides an overview of one example method that can be used to increase available storage capacity. Beginning with block 300, the user obtains (e.g., purchases) a storage device having a given, predetermined available storage capacity. Again, the purchase price of the storage device typically will reflect the amount of available storage capacity, with storage devices having less available capacity being less expensive and storage devices having more available capacity being more expensive. Once the storage device is purchased, the user uses the storage device a the host system. During this use, the user stores various data on the storage device, as indicated in block 302. For instance, where the host system comprises a digital camera, the user may store a plurality of images on the storage device.

As the user fills the available memory of the storage device, he or she may, as indicated in block 304, determine that more storage capacity is needed than is currently available from the storage device. In such a case, the user can contact a memory enablement agency, as indicated in block 306, which is capable of facilitating the expansion of the available storage capacity. By way of example, the enablement agency can comprise the manufacturer of the storage device or one of its agents. The user may contact the enablement agency in a variety of different ways. In one arrangement, the user can simply call the enablement agency to reach a representative of the agency. In another arrangement, the user can send facsimile or email transmissions to the agency. In a further arrangement, the user can connect with a network resource (e.g., Web server) of the enablement agency that is designed to facilitate the expansion process.

Irrespective of the manner in which the user contacts the enablement agency, once contact has been established, appropriate identification information can be provided by the user to the agency, as indicated in block 308. By way of example, this information can comprise a general passcode associated with the device, or the identity of the user. In another scenario, this information can comprise a public key associated with the user's storage device. Where contact was made with the enablement agency through a manual process, for instance through a telephone call, a facsimile transmission, an email transmission, or accessing of a network site (e.g., Web site) of the agency, the user can provide this information to the agency. Alternatively, where the contact is made via a network connection, this identification information can be, optionally, automatically provided to the agency via network communications between the host system and the agency.

Once the identification information has been provided to the enablement agency, the agency can provide to the user, or the user's host system, an appropriate memory enablement code that will enable the storage device controller to expand the available storage capacity, as indicated in block 310. The nature of this code will depend upon the nature of the security scheme that has been implemented. The memory enablement code can be, for instance, a code that, when provided to the storage device controller, instructs the controller to enable a certain portion of device memory. Where the user provided a public key associated with the storage device, the memory enablement code can comprise a passphrase that has been encoded with the provided public key.

Next, the memory enablement code is provided to the storage device controller, as indicated in block 312. This provision can comprise manual entry of the memory enablement code by the user using the host system interface, or transmission to the storage device from the host system. In any case, the provision of this memory enablement code instructs the storage device controller to enable an additional portion of free (i.e., previously unused) space of the device memory, as indicated in block 314.

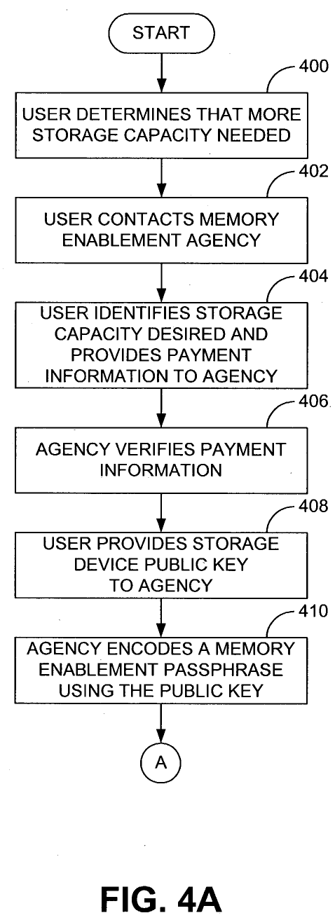

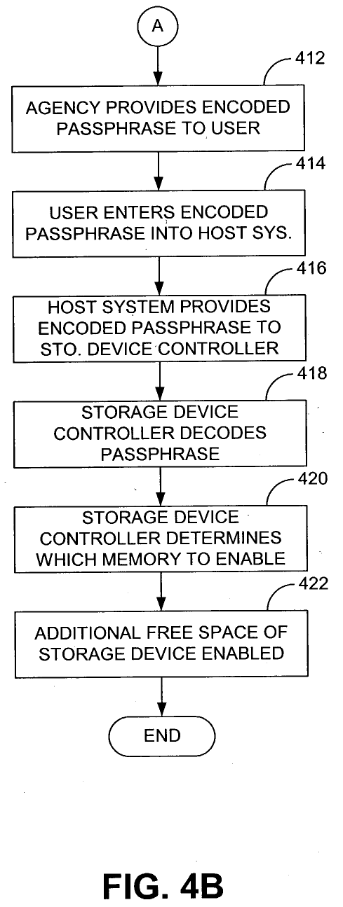

FIGS. 4A and 4B illustrate another example method that can be used to increase available storage capacity of the storage device. In particular, these figures illustrate a substantially manual memory enablement procedure in which public key encryption is used. Beginning with block 400 of FIG. 4A, the user determines that more storage capacity is needed. The user then contacts the memory enablement agency, as indicated in block 402, by, for instance, calling the agency.

Through this contact, the user can specify the amount of new storage capacity desired and provide payment information to the agency, as indicated in block 404. The fee charged to the user typically depends upon the amount of new memory the user wishes to be enabled. By way of example, the payment information can comprise an account number, such as a credit card account number, and any required user identification information (e.g., payment address, social security number, etc.). Once the payment information is received, the enablement agency verifies this information, as indicated in block 406. Assuming that the payment information is valid, the memory enablement procedure continues with the user providing a public key of the storage device to the agency, as indicated in block 408. Typically, this public key comprises a string of characters unique to the user storage device. By way of example, this public key can be printed on the outer housing of the storage device so that it can be conveniently located by the user.

Once the public key is provided to the agency, the agency encodes a memory enablement passphrase using the provided public key, as indicated in block 410. As is discussed below, this passphrase will be used to enable the new memory on the storage device. This passphrase reflects the amount of new memory requested by the user. Like the public key, this encoded passphrase typically comprises a unique string of characters. Notably, the encoded passphrase does not need to be further encrypted or otherwise secured in that, as is discussed below, the passphrase will only work with the target storage device. Referring next to block 412 of FIG. 4B, the agency then provides the encoded passphrase to the user and, as indicated in block 414, the user enters it into the host system that uses the storage device. The nature of this entry depends upon the nature of the host system. For instance, where the host system comprises a notebook computer, entry of the passphrase may be accomplished using the keyboard of the computer. Where the host system comprises a digital camera, entry may be accomplished using various interface keys or buttons of the camera.

As identified in block 416, the host system provides the encoded passphrase to the storage device and, more particularly, the storage device controller. Executing an embedded decoder program and using a private key (e.g., stored in ROM 206), the passphrase is decoded, as indicated in block 418, so that, as indicated in block 420, the controller can determine which, i.e. how much, new memory to enable. After this determination has been made, the additional free space of the storage device is enabled by the controller, as indicated in block 422. Enablement of the new memory may comprise, for instance, storing a flag in an appropriate database (e.g., table) within device memory (e.g., the non-volatile memory of the memory modules 108). With this stored flag, the amount and location of all enabled memory are defined. Therefore, the controller can communicate the available storage capacity of the device to the host system as necessary.

Where the storage device comprises a card, the storage device may implement a Compact Flash (CF) interface, as described in CF+ and CompactFlash Specification, Revision ATA-4 Compatibility Working Group Draft 0.4., which is hereby incorporated by reference into the present disclosure. In such an implementation, memory addresses correspond to Logical Block Addresses (LBAs) used by the CF host, rather than Cylinder, Head, Sector (CHS) addressing. Many schemes to map LBAs to physical addresses are known. For ease of illustration herein, it is assumed that one block corresponds to one sector. The sector size and the number of sectors per block are often negotiable between the host and the storage device (e.g., card) depending on the implementation.

The host may determine the amount of memory on the storage device using a Identify Drive (ECh) command. In such a case, the controller responds with an information block containing a variety of information about the storage device, such as firmware version, serial number, and capacity. In existing CF cards, the controller always replies with the same capacity, corresponding to the amount of physical memory on the card. With embodiments of the invention, however, the controller responds with the amount of memory enabled, regardless of the physical memory capacity. An example table that can be maintained by the controller in non-volatile memory is illustrated in Table 1 (all values are hex):

TABLE 1

| Passphrase (decoded) | Capacity (xx) | Flag |
|---|---|---|
| 00 | 02 | 1 |
| 01 | 02 | 0 |
| 02 | 04 | 0 |
| 03 | 06 | 0 |
| 04 | 08 | 0 |
| 05 | 0A | 0 |
| 06 | 0C | 0 |
| 07 | 0E | 0 |
| 08 | 10 | 0 |
| FF | | |

In this context, “passphrase” is the decoded phrase corresponding to the amount of memory to be enabled. In this particular example, the card can be set to a “default” capacity by sending a passphrase of zero. “FF” indicates the end of table. The selection of passphrases for each capacity may be arbitrary. The “capacity” is the amount of memory to be enabled upon receiving a given passphrase. In this example, the capacity corresponds to an address of xx00000h, so that capacity may be enabled in two-megabyte increments. The corresponding address will be the first invalid address. In this example, the “flag” is set to true (1) for a particular passphrase (“00” in Table 1) to indicate the currently enabled capacity. Upon receiving an Identify Drive command, the controller can look up the capacity corresponding to the first true flag in the table, divide the capacity by the sector size, and respond to the command with the resulting number of enabled sectors in bytes 7-8.

Currently, the CF specification does not directly support setting a card capacity per embodiments of the invention. Therefore, the Set Feature (Efh) command can be used with an unused feature code (byte 1) to set the capacity of the storage device (e.g., card). For this example, assume the capacity feature code 10h and Config (byte 2) contains the encoded passphrase. To set a new capacity, the host sends a Set Feature command with the Feature code set to 10h and the Config field containing the encoded passphrase. Upon receiving the command, the card controller decodes the passphrase using the private key, looks up the passphrase in the table, sets the corresponding flag, and then clears all other flags in the table. If the passphrase is improperly encoded or the passphrase does not have an entry in the table, the controller will respond with a ‘command aborted’ as described in the CF specification.

There are several commands available in the CF specification to read and write data. By way of example, the Write Sector (30h) command can be used. As will be appreciated by persons having ordinary skill in the art, other read and write commands will operate in a similar fashion. When the controller receives a Write Sector command, the controller adds the sector count to the LBA (end LBA), looks up maximum capacity flagged in the capacity table and divides by the sector size (max LBA), then compares the two results. If the end LBA is greater than the max LBA, then the controller reports an error in compliance with the CF specification.

To speed operation, the max LBA can be calculated and stored in a register upon power up when a new capacity is set or when the sector size is changed. This mode of operation saves searching the look-up table for the maximum capacity and calculating the max LBA each time a read or write command is executed.

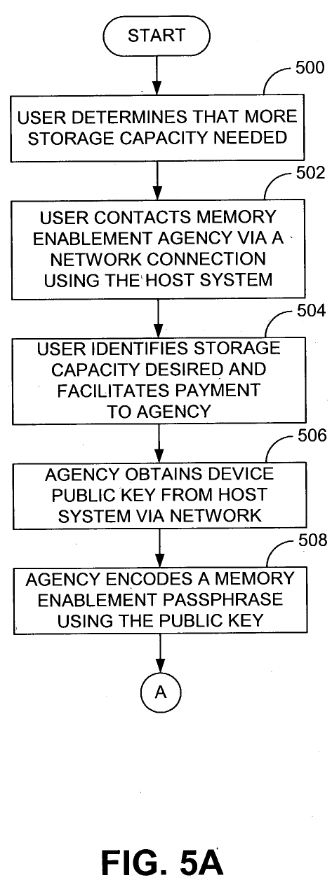

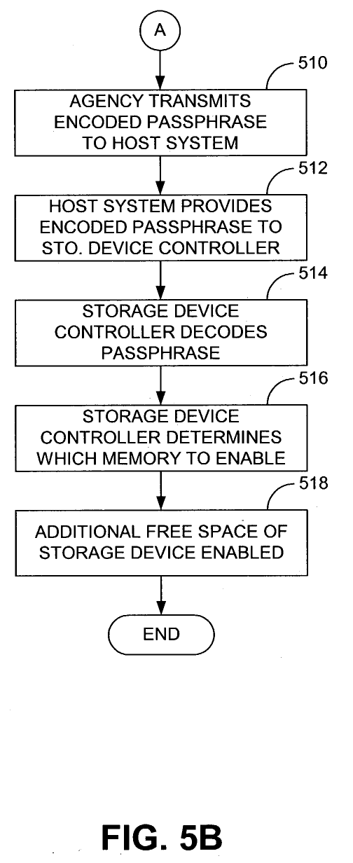

FIGS. 5A and 5B illustrate another example method that can be used to increase available storage capacity of the storage device. In this method, a substantially automated enablement process is used which again employs upon public key encryption. Beginning with block 500 of FIG. 5A, the user determines that more storage capacity is needed. The user then contacts the memory enablement agency via a network using the host system, as indicated in block 502. Accordingly, in this method, the host system is network-enabled. As will be appreciated by persons having ordinary skill in the art, the network connection can be facilitated by a wired or wireless connection.

Through the network connection, the user identifies the amount of new storage capacity desired and facilitates payment to the agency, if such payment is required, as indicated in block 504. This information can be entered using, for instance, a user interface of a network site (e.g., Web site) hosted by the agency. Facilitating payment may again comprise providing payment information, such as a credit card account number, or may comprise simply authorizing payment from an account that has been previously identified to the agency.

Assuming the payment information to be valid and/or appropriate funds available in the previously-identified account, the agency then obtains the storage device public key from the user's host system via the network, as indicated in block 506. By way of example, this can be accomplished by the agency by transmitting a request communication to the host system and then receiving a reply communication that contains the public key from the host system.

Once the public key is received by the agency, the agency encodes a memory enablement passphrase using the provided public key, as indicated in block 508, and transmits the encoded passphrase to the user host system, as indicated in block 510 of FIG. 5B. The host system, in turn, provides the encoded passphrase to the storage device controller, as indicated in block 512. At this point, the device controller decodes the passphrase, as indicated in block 514. Once the passphrase is decoded, the controller can determine how much new free space to enable on the storage device, as indicated in block 516, and therefore enable the addition memory, as indicated in block 518.

Because of the network connection between the host system and the agency, added utility can be obtained. For instance, the agency could be used as a data backup service in which data stored on the storage device can be uploaded to the agency for archiving. In such a scenario, the capacity of the storage device would, in effect, be increased as would data reliability. Implementation of such a system would involve, for example, the added steps of the storage device controller transmitting stored data to the host system, the host system transmitting the data to the agency, and the agency storing the data in agency memory for later access by the user (e.g., web access). Such a system would be particularly useful for situations in which the user is in a remote location, for instance while on vacation, and needs greater storage capacity. Not only could the user increase the capacity of his storage device, but the user could further upload his or her data to the agency (e.g., in return for a fee) to free more memory on the storage device so that more data (e.g., photographs) could be stored.

Although the new memory has been described as being permanently enabled by the controller, persons having ordinary skill in the art will appreciate that memory enablement can be temporary where the storage device controller comprises an appropriate clock functionality. In an alternative on this theme, the memory can be enabled for a given, limited number of accesses. In either scenario, flow is substantially the same as described in the examples described in relation to FIGS. 14-16, although the communication from the agency to the controller would, in addition to providing indication as to how much more memory to enable, include information as to how long to enable the memory or provide a lock-out on the newly-enabled memory after a given number of accesses.

What is claimed is:

1. A storage device, comprising:
a memory module; and
a controller in communication with the memory module, the controller being configured to selectively enable previously inaccessible free space of storage device memory to increase the available storage capacity of the storage device.

2. The device of claim 1, wherein the memory module is an atomic resolution storage (ARS) module.

3. The device of claim 1, wherein the memory module is a magnetic random access memory (MRAM) module.

4. The device of claim 1, wherein the memory module is a write-once memory module that includes a cross-point array of thin-film, write-once memory cells.

5. The device of claim 1, wherein the controller includes a decoder that is configured to decode a memory enablement code that identifies how much free space is to be enabled.

6. The device of claim 5, wherein the controller comprises read-only memory (ROM) and the decoder is an embedded decoder program stored within the ROM.

7. The device of claim 5, the controller further comprising a private key stored within the controller that is used to decode the memory enablement code.

8. The device of claim 1, wherein the storage device is a storage card.

9. A storage device, comprising:
a solid-state memory module; and
a controller that is configured to selectively enable previously inaccessible free space of storage device memory to increase the available storage capacity of the storage device, the controller including a decoder that is configured to decode an encrypted passphrase that identifies how much free space is to be enabled.

10. The device of claim 9, wherein the memory module is one of an atomic resolution storage (ARS) module, a magnetic random access memory (MRAM) module, and a write-once memory module that includes a cross-point array of thin-film, write-once memory cells.

11. The device of claim 9, wherein the controller comprises read-only memory (ROM) and the decoder comprises an embedded decoder program stored within the ROM.

12. The device of claim 9, further comprising a private key stored within the controller that is used to decode the encrypted passphrase.

13. The device of claim 9, wherein the storage device is a storage card.

14. A removable storage card for use with a host electronic device, comprising:
an atomic resolution storage (ARS) module; and
a controller that is configured to selectively enable previously inaccessible free space of storage device memory to increase the available storage capacity of the storage device, the controller including an embedded decoder program that is configured to, using a private key stored within the storage card, decode a passphrase that has been encoded with a public key associated with the private key, to thereby selectively enable the previously inaccessible free space based in part on the decoded passphrase.

15. An electrical device, comprising:
a storage device including a memory module and a controller, the controller being configured to selectively enable previously inaccessible free space of storage device memory to increase the available storage capacity of the storage device.

16. The electrical device of claim 15, wherein the memory module is one of an atomic resolution storage (ARS) module, a magnetic random access memory (MRAM) module, and a cross-point array of thin-film, write-once memory cells.

17. The electrical device of claim 15, wherein the controller includes a decoder that is configured to decode a memory enablement code that identifies how much free space is to be enabled.

18. The electrical device of claim 17, wherein the controller comprises read-only memory (ROM) and the decoder is an embedded decoder program stored within the ROM.

19. The electrical device of claim 15, wherein the storage device is a removable storage that can be inserted into and removed from the electrical device.

20. The electrical device of claim 15, further comprising a user interface with which a user can enter information into the electrical device.

21. The electrical device of claim 15, further comprising a network interface with which the electrical device can communicate with a network.

22. A method for increasing the available storage capacity of a storage device having an initial available storage capacity, comprising:
providing identification of the amount of storage capacity that is needed;
receiving a memory enablement code that identifies how much new free space to enable on the storage device; and
enabling additional free space of the storage device based upon the amount of free space identified by the memory enablement code so as to increase the available storage capacity of the storage device.

23. The method of claim 22, wherein providing identification comprises providing identification of the amount of storage capacity that is needed via a network.

24. The method of claim 23, wherein receiving a memory enablement code comprises receiving a memory enablement code via a network.

25. The method of claim 24, wherein the memory enablement code is a passphrase that is encrypted with a public key associated with the storage device, and further comprising decoding the passphrase using a private key stored within the storage device.

26. A method for increasing the available storage capacity of a storage device having an initial available storage capacity, comprising:
notifying a memory enablement agency of a need for increased storage capacity;
receiving a memory enablement code from the enablement agency that identifies how much free space to enable on the storage device; and
enabling additional free space of the storage device based upon the amount of memory identified by the memory enablement code so as to increase the available storage capacity of the storage device.

27. The method of claim 26, further comprising providing payment authorization to the enablement agency.

28. The method of claim 26, further comprising providing identification information to the enablement agency.

29. The method of claim 26, wherein each of notifying a memory enablement agency, providing payment authorization, providing identification information, and receiving a memory enablement code are facilitated via network communications.

30. The method of claim 26, wherein providing identification information comprises providing a public key associated with the storage device.

31. The method of claim 26, wherein receiving a memory enablement code comprises receiving a passphrase encrypted using a public key.

32. The method of claim 26, wherein enabling additional memory comprises decoding a passphrase using a private key associated with the public key to determine how much free space to enable.

33. A method for increasing the available storage capacity of a storage device having an initial available storage capacity, comprising:
receiving identification of a need for increased storage capacity;
providing a memory enablement code that identifies how much free space to enable on the storage device and which is configured to enable a controller of the storage device to enable the additional free space.

34. The method of claim 33, further comprising receiving payment authorization for memory enablement.

35. The method of claim 33, further comprising receiving identification information.

36. A system for increasing the available storage capacity of a storage device having an initial available storage capacity, comprising:
a host device;
a memory enablement agency; and
a storage device associated and in communication with the host device including a memory module and a controller that is configured to selectively enable previously inaccessible portions of storage device free space in response to information received from the memory enablement agency to increase the available storage capacity of the storage device.

37. The system of claim 36, wherein the host device comprises a network interface with which the host device can connect to a network.

38. The system of claim 36, wherein the storage device is a storage card that is insertable into and removable from the host device.
